(19) United States
(12) Patent Application Publication
(10) Pub. No.: US 2011/0035041 A1
(43) Pub. Date: Feb. 10, 2011

(54) Systems and methods for feed control of rolled stock raw materials

(76) Inventor: Stephen J. Habakus, Easton, PA (US)

Correspondence Address: Christopher J. Whewell;Western Patent Group, 6020 Tonkowa Trail, Georgetown, TX, 78628, US

(21) Appl. No.: 12/462,618

(22) Filed: Aug. 6, 2009

(51) Int. Cl. G06F 17/00

(52) U.S. Cl. 700/108; 702/155

(57) ABSTRACT

System and method for controlling the feed of a raw material disposed on a roll into a continuous or semi-continuous production process are provided. According to the disclosure, a user-defined amount of remnant material that is desirably left on the core of a roll of material when the roll is to be considered is depleted is provided as a process input, and a system according to the disclosure repeatedly evaluates and relates the stop length of material that passes through a process when a production line is stopped, the remnant material amount, and the amount of material currently present on a roll at various times during unwinding of the roll during process operation. Use of a system and/or method as provided enables operators of processes using rolled stock as a raw material to achieve heretofore un-attainably small amounts of scrap generation due to remnant material left on the roll's core.

### TECHNICAL FIELD

The present invention relates generally to production processes which utilize a raw material provided on a roll as a feed. More particularly, it relates to apparati and methods for determining points in time when it is advantageous to provide a fresh roll of a raw material feed.

### BACKGROUND OF THE INVENTION

Many production processes are carried out on continuous-feed production lines which utilize a raw material that is provided on a roll as a feed to the process. Examples of such processes include without limitation: printing lines to which written characters and/or graphics are provided on a moving substrate, coating processes such as extrusion coating processes, laminating processes, slitting processes in which width adjustments are made to a rolled stock material, and rewinding processes. Thus, it is known in the art that raw materials that are provided on a roll (rolled stock) can include polymeric films, paper, metal foils including copper and aluminum foils, textiles and fabrics.

During a production process that utilizes a rolled stock raw material it inevitably occurs at some point in time that the rolled stock raw material becomes depleted from the roll on which it was previously disposed. At such a point in time for many production lines, the production line must be shut down (stopped) in order that a fresh roll of rolled stock material may be positioned into place, and the process again commenced. Other production lines are configured to be equipped with an automatic cutover capability, which enables a process operator to provide a fresh roll of rolled stock material to the process apparatus without any need for shutting down the production line. Thus, regardless of the configuration of an apparatus useful in carrying out a production process that utilizes a rolled stock raw material, a point in time eventually arrives where a fresh roll of rolled stock material must be provided.

In the case of a typical continuous process utilizing a rolled stock material as a raw material feed, such as screen printing, if a roll of rolled stock were permitted to be completely depleted, the entire production line must be shut down and a new roll of material re-threaded into the apparatus. For this reason operators of such equipment typically shut down the line prior to a roll of feedstock material becoming depleted, place a new roll into place and adhere or attach its initial leading edge onto a portion of the rolled stock already present in the apparatus, prior to re-commencement of the process. Such attachment saves a great deal of downtime and wasted raw material stock over the case where a roll is permitted to be depleted, since it is usually the case that much of the early product from an initial feeding is out of specification. However, a problem in the art associated with changing a roll of rolled stock material is inconsistencies in the exact amount of rolled stock material present on each roll provided by a supplier. While suppliers of such materials attempt to provide uniform amounts, there are always deviations present. Furthermore, even if the length of material on a given roll is known, it is often necessary for production line operators to remove some non-predictable and variably-unknown amount of material from the outside diameter of a fresh roll of rolled stock raw materials. One reason for this is due to physical damage to such rolls imparted during transportation or handling of a roll. Removal of outer wraps of material on a roll (known in the art as “slabbing”) effectively invalidates a previously-supposed length of material contained on such fresh rolls. Thus, due to the costs associated with the case where a roll is permitted to become completely depleted, operators typically stop such processes well before a roll of rolled stock material has become depleted, to err on the side of safety. While good practice in general for avoiding the necessity to re-thread a roll of new material into the processing apparatus, this nevertheless results in various amounts of un-usable rolled stock material to be left behind on rolls whose value is no greater than the residual scrap value of the remnant material on the roll. Complicating matters is that a production line cannot be simply stopped instantaneously, rather there is an amount of time required for deceleration of the line to a stop, which increases the skill level requirement of any operator desirous of replenishing a rolled stock material to the process. Moreover, on many production lines employing a rolled stock material as a raw material feed, there is a threshold line speed below which, although the web of material is in motion, unacceptable product is produced. Some of the same general considerations apply to the case of continuous production apparati which are configured to enable an operator to change out a roll of raw material feed stock while the process remains in operation.

Thus, operators of such processes in general face a dichotomy that the manual timing of a line stop command almost always causes a significant amount of otherwise usable material to be present on a spent unwind core, while the alternative to leaving some material on the core is the loss of the tail of the material from a previous roll through the apparatus, which requires manually re-threading the line, some expenditure of time for clean-up and production of some off-specification material.

One approach attempted by workers in the art to lessen the effects of this dichotomy is to employ a discrete sensor to detect the point in time during line operation at which the diameter of the unwind roll containing the rolled stock material is below a threshold value. Such an approach is generally beneficial only when the following characteristics are present and associated with the process under consideration: 1) the run speed of the line for all products produced on the line under consideration is always identical; and 2) the thickness of all rolled stock materials used as a raw material feed is always identical. Unfortunately, for a large number of processes employing a feed material in the form of a rolled stock disposed on a core as described above, if not most, these characteristics are not present and such an approach still leaves substantial amounts of otherwise-useful raw material stock on the roll core.

### SUMMARY OF THE INVENTION

Methods and systems for controlling a production line process that utilizes a raw material provided on a roll as a feed. A method according to an embodiment of the disclosure comprises defining an amount of the raw material that is desired to be left on the roll when the roll is to be considered as being depleted; feeding the raw material into the production line during the operation of the process; determining a stop length of the raw material that passes through the production line when feeding of the raw material into the production line is halted; determining the thickness of the material on the roll; determining the amount of material present on the roll during the operation of the production line; relating the amount of material present, the stop length and the amount of the raw material desired to be left on the roll to one another, to provide a comparison; and commanding an action concerning the operation of the production line responsive to the comparison.

### BRIEF DESCRIPTION OF THE DRAWINGS

Embodiments of the present disclosure may take physical form in certain parts and arrangement of parts, the preferred embodiment of which will be described in detail and illustrated in accompanying drawings which form a part hereof, and wherein:

FIG. 1 is a side schematic view of various elements useful in providing an apparatus useful for carrying out a process according to embodiments of the disclosure; and

FIG. 2 shows a block diagram depicting various elements present and their cooperative connection to one another in a structural arrangement provided by the disclosure.

### DETAILED DESCRIPTION INCLUDING PREFERRED EMBODIMENT

The present disclosure provides methods and apparati for practicing the methods, to enable changing or replenishing a spent roll of raw material with a fresh roll in a process that utilizes a rolled stock raw material as a feed, such that there is nearly no un-used raw material remaining on roll cores used to carry the rolled stock raw material.

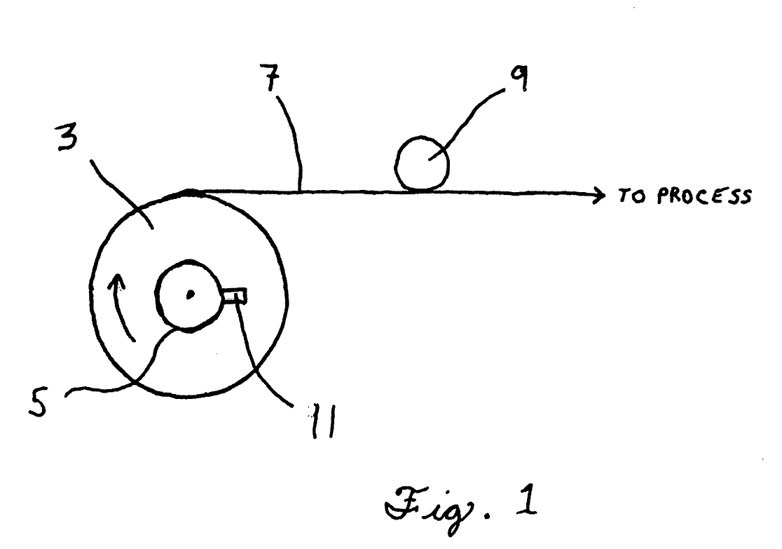

Referring now to the drawings, wherein the showings are for the purpose of illustrating the invention only and not for the purpose of limiting the same, FIG. 1 shows a side view of a roll 3 of rolled stock raw material present as a plurality of wound layers on a core 5, which core 5 itself is typically rotably disposed about a spindle sufficient to enable the rolled stock raw material to be drawn off the core as demanded by the process, causing rotation of the roll 3 of material and core 5 in the direction indicated by the arrow. This rolled stock raw material is thus provided as a roll 3 as a feed or input for a continuous or semi-continuous production process.

During a typical operation, a web 7 of rolled stock raw material is drawn off the roll 3 by rollers (not shown) or other structures downstream in a production process which grasp or pull on the web 7 such as by frictional engagement therewith, unwinding the roll 3 and drawing the web 7 into any of a wide variety of process machinery, as such machinery so equipped is well-known in several fields of art, including without limitation those mentioned in the Background section above.

According to the present disclosure, process equipment embodying the features shown in FIG. 1 is provided with a first sensor 9, which in one embodiment is an incremental encoder having a fairly high number of pulses per revolution. One non-limiting example of a suitable incremental encoder useful as first sensor 9 for embodiments of the disclosure is model number 725 made by Encoder Products Company Inc. of Sagle, Id. The incremental encoder can be mechanically coupled to the process line in a number of different ways, known in the art. In one embodiment the incremental encoder is coupled to a wheel of a known circumference, with the wheel itself being in contact with or riding on the moving web 7; however other known methods of providing effective sensing contact or proximity for this and other sensors employed herein to be used as herein described may be utilized. An incremental encoder as used herein provides information concerning the length of material that moves through the line, and is also useful for determining the speed of the web 7 as it moves through a production line. Although an incremental encoder is useful as a first sensor 9 in accordance with the disclosure, other devices are suitable for use as first sensor 9 provided that they are capable of accurately, reliably, and with a high degree of precision, measuring the length of material that is removed from an unwinding roll of stock material. Such devices include without limitation: Laser Doppler Velocimetry sensors, and rotopulser sensors.

FIG. 1 also shows a second sensor 11, which in some embodiments is a proximity sensor. Second sensor 11 functions to provide information concerning revolutions of the roll 3. In one embodiment, second sensor 11 turns on and off once for every revolution of the roll 3 when the line speed of the process is greater than zero. Although a proximity sensor is useful as a second sensor 11 in accordance with the disclosure, other devices are suitable for use as second sensor 11 provided that they are capable of accurately, reliably and repeatably sensing the angular position of the unwinding roll at one or more equally-spaced angular positions. One non-limiting example of a device useful as second sensor 11 for embodiments of the disclosure is model number AE 1-AP-1F made by Automation Direct of Cumming, Ga. USA. Such devices include without limitation: limit switches, and photoelectric devices.

Embodiments of this disclosure generally include a determination of initial parameters present after providing a new roll 3 to a process referred to herein as D1 and resetting a revolution register as described below, and performing on-going calculations while a roll 3 in a process is being depleted of material, i.e., the line speed is greater than zero.

According to embodiments of the disclosure, when a new roll 3 of material is put into service in a production line as referred to herein, the starting or initial roll diameter of the roll 3 is determined, using inputs provided by first sensor 9 and second sensor 11. By observing the pulse count from first sensor 9 for each revolution of roll 3, i.e., from one moment in time that the second sensor 11 turns on until the next moment in time that the second sensor 11 turns on, the circumference of the unwinding roll 3 is effectively measured. Such measurement is highly accurate, due to the inherently-high resolution of the first sensor 9. Equation (1) below provides a determination of the initial roll diameter of roll 3:

Initial Diameter (D1)=Circumference/π (1)

It is permissible within embodiments of the disclosure to delay the capture of D1 until after a few revolutions of roll 3 have transpired in order to obtain a stable value for D1.

According to embodiments of the disclosure, there is a revolution register present for maintaining a tally of the number of revolutions of the roll 3 which transpire as the rolled stock raw material passes through the production line, as detected by the second sensor 11. Such a register may be zeroed prior to, concurrently with, or subsequent to the determination of D1. However, in a preferred embodiment the register is zeroed concurrently with the determination of D1. In some embodiments the tally of the register is zeroed concurrently with the capture of D1.

During a process employing stock provided on a roll 3 for which a method, system, and/or apparatus as herein provided is associated, as the unwinding roll 3 is depleted of material the current roll diameter of roll 3 is periodically calculated using the outputs of first sensor 9 and second sensor 11, at any points in time pre-selected by process engineers. By observing the pulse count from first sensor 9, for each rotation of the roll 3, i.e., from the moment in time that second sensor 11 turns on until the next moment in time that second sensor 11 turns on, the circumference of the unwinding roll 3 is repeatedly measured. Knowing the circumference of the roll 3 enables determination of the current diameter of roll 3 using equation (2):

DiameterPV (D2)=Circumference/π (2)

with DiameterPV representing a process variable that is actually measured, PV representing “process variable”.

Also occurring during a process employing stock provided on a roll 3 for which a method, system, and/or apparatus as herein provided is associated or applied, concurrently with the determination of Diameter PV (D2), a revolution register is incremented once per revolution as the unwinding roll 3 is depleted of material subsequent to the re-setting of the counter mentioned above, providing a number of revolutions value R1.

One determination that is undertaken during a process employing stock provided on a roll 3 for which a method, system, and/or apparatus as herein provided is associated or applied is determination of the thickness of the material provided on roll 3, also called Material Thickness PV. This is determined using equation (3) below by knowing how much the roll diameter has changed over an observed number of revolutions of roll 3 as it is being unwound:

ThicknessPV(T1)=(D2−D1)/(2*R1) (3)

in which the asterisk * used herein denotes multiplication.

Another determination that is undertaken during a process employing stock provided on a roll 3 for which a method, system, and/or apparatus as herein provided is associated or applied is determination of the length of material remaining on roll 3 at any selected point in time, which may be referred to as the Remaining LengthPV or (Lr). The length of the material that remains on the unwinding roll 3 is determined through knowledge of and relation among the current roll diameter (D2), the diameter of the bare core 5, termed (Dc), and the thickness of the material according to equation (4) below:

Remaining LengthPV (Lr)=(π*((D2*D2)−(Dc*Dc)))/(4*T1) (4)

Another determination that is undertaken during a process employing stock provided on a roll 3 for which a method, system, and/or apparatus as herein provided is associated or applied is determination of the line speed of the production line process. The current line speed at any given point in time or average over any selected interval is determined based upon the frequency of the output of the first sensor 9. This provides Current Line Speed PV, also referred to as (S1).

Another determination that is undertaken during a process employing stock provided on a roll 3 for which a method, system, and/or apparatus as herein provided is associated or applied is determination of the amount of time required for stopping the feed of the raw material disposed on roll 3 on the production line or into the process. This may also be referred to as Deceleration Time (DecelTime) that transpires during a Line Stop, (Dt), and can be determined by knowledge and relation of the rate of deceleration of the line, which is a configuration value that may vary among different processes, inherent in their operation. The Deceleration Rate (Dr) of a given process line is a configurable constant, having units of length per time squared, which is readily determinable. Thus, the Deceleration Time is provided by equation (5) as:

Deceleration Time (Dt)=S1/Dr (5)

Equation (5) assumes a generally trapezoidal ramp profile, and those of ordinary skill in the art recognize that the equation used for cases of S-shaped profiles will be slightly different.

Another determination that is undertaken during a process employing stock provided on a roll 3 for which a method, system, and/or apparatus as herein provided is associated or applied is determination of the stop length of the raw material disposed on roll 3 that passes through the production line during stopping the feed of the raw material into the production line, which may be referred to as the Stop Length, (Ls). At a given moment in time, if the line is stopped at the current Line Speed, the amount of material that will be consumed, by entering the process equipment or otherwise, before the line speed reaches zero is provided by equation (6):

Stop Length (Ls)=(S1*Dt)/2 (6)

Equation (6) assumes a generally-trapezoidal ramp profile, and those of ordinary skill in the art recognize that the equation to be used in cases for which the ramp profile is S-shaped will differ slightly.

The foregoing determinations having been accomplished, it now becomes possible to make a comparison between the length of material remaining on roll 3, (Lr) to the Stop Length (Ls). For the case where:

Lr≦(Ls+Lm) (7)

and other cases of comparison of Lr and Ls, as may be pre-selected by engineers or other personnel relating to these variables, an action may be commanded responsive to the foregoing determinations based on inputs provided by first sensor 9 and second sensor 11, wherein Lm is a user-defined variable length of material that is desired to be left on the roll 3 after the line has been decelerated to a stop. The action commanded may be a line stop command to stop the production line, and may alternatively comprise a material cutover command instructing a process operator to “cut over now” (switch rolls), on those production lines which enable furnishing a fresh roll 3 of material while the line remains in motion. Mathematical expressions that yield the same effective result respecting a production line as does the relation of (7) are within this disclosure, as such are known to be substantially equivalent in effect by those of ordinary skill in mathematics, whereby the amount of material present, the stop length and the amount of raw material desired to be left on the roll are repeatedly related during the production process, to provide a plurality of successive comparisons. In one embodiment, successive determinations of the difference between the amount of material present (remaining) on a roll to the stop length may be used to provide a plurality of successive values for comparison until a pre-selected threshold value or condition becomes present, at which time an action relating to the operation of the production line is commanded. In an alternate embodiment, successive determinations of the difference of the amount of material present on a roll and the stop length may be used to provide a plurality of successive comparison values and once such a difference reaches a pre-selected threshold, an action concerning operation of the production process line is commanded. Thus, a method according to one embodiment of this disclosure includes repeatedly relating the amount of material present on the roll and the stop length to one another during a production process to provide a plurality of successive comparison values, the comparison being made by any mathematical relation that provides a desired amount of unused raw material to remain on the roll after the production process line is stopped.

In some embodiments as the unwinding roll 3 is depleted of material, the continuously calculated Remaining LengthPV, (Lr) becomes smaller and smaller. Eventually, the comparison between (Lr) and (Ls) per the foregoing will make the relation (7) true, and the control system is readily configurable to generate a Line Stop Command causing the production line to decelerate to a stop and enable replenishing the line with a fresh roll 3 of raw material stock.

One benefit encountered when operating according to a method as herein disclosed is that the determination of material thickness becomes increasingly accurate as the number of revolutions (R1) of the unwinding roll 3 increases. This, in turn makes knowledge of the Remaining Length PV (Lr) increasingly more accurate with the passage of time, causing a method described herein to be exceptionally beneficial towards reducing generation of un-necessary scrap material essentially to naught, saving vast quantities of raw materials that would have otherwise gone to waste when operating according to prior art methods.

For production processes having capability to automatically cutover from an expiring roll 3 to a new roll 3 on the fly while the process continues to operate, the commanded action is not to stop the production line bur rather to provide an indication of the desirability of providing a fresh roll 3 based on the length of material present on a roll being depleted, the length of which may be any length deemed desirable by personnel associated with the production line. Thus, the teachings herein are applicable to a wide range of process equipment configurations in many different industries that utilize raw materials provided in rolled form.

It is preferred to employ microprocessor control to a process as herein described which utilizes rolled stock as a raw material. Suitable microprocessors preferably include memory and are known in the art. One non-limiting example of a microprocessor suitable for carrying out a method according hereto is model number 1763-L16BBB made by Rockwell Automation of Milwaukee, Wis. However, other microprocessors may be used, as is appreciated by those skilled in the art as being capable of carrying out the determinations set forth herein. For this function various algorithms may be devised to achieve substantially the same result using the aforementioned components (or their substantial equivalents) and employing the various formulae and/or principles and/or combinations of principles taught herein.

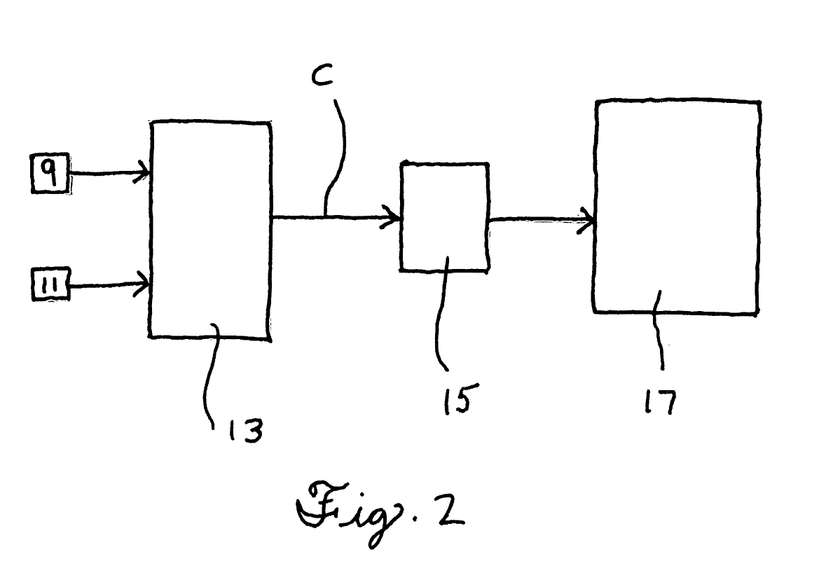

To carry out a method according to the present disclosure, one furnishes a first sensor 9 and a sensor 11 to the rolled stock in effective locations to provide sensing of the parameters mentioned. The outputs of these sensors are provided as inputs to a microprocessor 13 (FIG. 2) also configured as having at least one output, which microprocessor carries out the determinations described, and at an appropriate point in time during a production process, commands an action via an output of the microprocessor. The microprocessor output may be an interrupt command communicated directly to a microprocessor or other equipment 15 (FIG. 2) used to control the line speed of the production line to which a system and method as herein described are applied. In other embodiments, the microprocessor output causes a visual or audible indication on a lamp or sound transducer via tripping of a relay therefor, as such circuitry is well known in the art. The main criteria is determination of the point in time at which it is desired to provide a fresh roll 3 of material, responsive to the parameters herein determined and described, for once that point is reached the output signal from the microprocessor may be employed and used in ways output signals are known or typically handled in circumstances in manufacturing where an automated system indicates a required action on part of a process operator. Various determinations described herein are conducted on a repeat basis, during a process employing a rolled feedstock material as a raw material. The intervals at which these repeated determinations are made is a variable that may be pre-selected or pre-determined by process engineers. For example, the amount of material remaining on roll 3 during the process may be determined at essentially any interval between many times per second to once every 10 minutes, including all intervals and ranges of intervals therebetween.

Thus, in one embodiment of a method as provided herein, the following steps are undertaken, but not necessarily in the order set forth below except to the extent that a variable used in a later step must be determined from an earlier step, thence the earlier step is generally undertaken prior to the later step:
1) Operate production line;
2) Determine initial roll diameter D1; D1=Circumference/π and coincidentally zero the revolution counter (R1)
3) Begin counting revolutions of roll (R1);
4) Continue to operate production line;
5) Determine roll diameter D2; D2=Circumference/π
6) Determine material thickness; ThicknessPV (T1)=(D2−D1)/(2*R1)
7) Determine outer diameter of empty core; Dc
8) Determine Remaining Length of material; Remaining LengthPV (Lr)=(π*((D2*D2)−(Dc*Dc)))/(4*T1)
9) Determine Line speed; S1
10) Determine Deceleration time; Decel Time (Dt)=S1/Dr
11) Determine Stop Length; Stop Length (Ls)=(S1*Dt)/2
12) Make comparisons; When Lr<(Ls+Lm), then issue action command.
   In some embodiments, some of the operating variables/parameters as specified in Table I below are determined on an ongoing basis while the production line process is being carried out, at any intervals pre-determined by process engineers. In a preferred embodiment, the line speed and revolutions of the roll 3 are monitored constantly. In a preferred embodiment, calculation of D2 and R1 and parameters that depend on D2 and R1 are calculated or determined once per input event from sensor 11, preferably once per revolution of roll 3. Other parameters such as Linespeed PV (S1), DecelTime (Dt) are performed as frequently as the microprocessor 13 can perform them in order to achieve the highest degree of performance possible from the selected microprocessor. Table I below lists each of the various parameters herein, including units used in one embodiment:

TABLE I
Parameter Table

| Parameter | Short name | Units | Description |
|---|---|---|---|
| D1 | Diameter #1 | inches | Snapshot of DiameterPV (D2) when the roll 3 is started |
| D2 | DiameterPV | inches | Unwind Roll (roll 3) Diameter - continuously calculated as roll is depleted |
| Dc | CoreDiameter | inches | User-enterable configuration constant that identifies Outer Diameter of core |
| | | | 5. |
| Dr | ExpectedDecelRate | Inches/(min)\hat{ }2 | User enterable configuration constant that identifies how quickly the line |
| | | | will decelerate when a line stop command is given |
| Dt | ExpectedDecelTime | Minutes | Continuously calculated amount of time that is expected to transpire for the |
| | | | process machinery to fully stop from a current line speed. Dt = S1/Dr |
| | | | (for standard trapezoidal profile) |
| Lm | LengthMargin | inches | User enterable configuration constant that identifies the length of material |
| | | | that the user desires to have remaining on the unwind roll after the process |
| | | | machinery has come to a complete stop. |
| Lr | LengthRemainingPV | | Continuously calculated Length of Material that remains on roll 3. |
| | | | Lr = (*((D2 * D2) − (Dc * Dc)))/(4 * T1) |
| Ls | StopLength | inches | Continuously calculated length of material that will pass through process |
| | | | machinery during the deceleration time period. |
| | | | (Ls) = (S1 * Dt)/2 |
| R1 | Rev Counter | count | Counts revolutions of roll 3. Reset to zero when a new roll is installed. |
| S1 | LineSpeedPV | Inches/min | Continuously calculated Line Speed (i.e., web speed). This is simply |
| | | | calculated by linearly scaling the frequency of the signal of first sensor 9. |
| T1 | MaterialThicknessPV | Inches | Continuously calculated based upon the measured change in diameter |
| | | | divided by the measured number of roll 3 revolutions. |
| | | | (T1) = (D2 − D1)/(2 * R1) |

In FIG. 2 is shown a block diagram depicting various elements present and their cooperative connection to one another in a structural arrangement provided by the disclosure. In FIG. 2, there is microprocessor 13 having inputs configured to receive the outputs of first sensor 9 and second sensor 11. Once a method according to the disclosure has been carried out, an action command C is provided as an input to process control equipment 15, which process control equipment 15 is configured to control the speed of the moving web in the process 17. In some process control equipment 15, line speed is not used as a parameter when changing a roll, rather, equipment is configured to receive a command to cut-over to a new roll “on the fly”, as such equipment is known in the art. Command C may be either a command to stop the production line, an indication to an operator to cut over now” to a new raw material roll 3, or a signal to the production line controller to cut-over to a new roll immediately. It is not necessary for production process lines that are configured to cut over to a new roll “on the fly” to determine a stop length of material. For such production process lines the output signal from the present disclosure comprises an input to line control equipment commanding the line to “cut over now”. The generation of a signal associated therewith is more simplistic than other embodiments of the disclosure in which the process line must come to a stop, and entails a comparison of the remaining length of material on the roll (Lr) to the desired amount of material to remain on the roll (Lm) when the roll is to be considered as being spent. For such instances, the pertinent comparison is relates to the time interval at which Lr is less than or equal to Lm, as desired by engineers or process operators. Thus, in some embodiments all steps of the process set forth in claim 1 as originally filed herein are employed, whereas in other embodiments the step of determining a stop length is omitted. The comparison determinative of the moment in time when action is commanded, for example “cut over now” to a new roll of material, instead of “begin decelerating to a stop now” is when Lr Lm. In one alternate embodiment in a system as provided herein the configuration value for the “Deceleration Rate” of the line is set to a very large number, to simulate that the equipment can effectively decelerate instantaneously. In this approach, a Stop Length of essentially zero is calculated.

Consideration must be given to the fact that although inventions provided herein have been described and disclosed in relation to certain preferred embodiments, modifications and alterations thereof providing an equivalent or substantially-equivalent outcome may become apparent to persons of ordinary skill in this art after reading and understanding the teachings of this specification, drawings, and the claims appended hereto. Thus, although various lengths of materials are specified as being determined herein, it is equivalent to consider the amount of material, for example, the length of material on a roll is equivalent to expressing the amount for example, in kilograms, through known conversion factors. Thus, length of material remaining on a roll may be considered as being an equivalent expression of the amount of material remaining on a roll within the context of some embodiments described in this disclosure. The present disclosure includes subject matter defined by any combinations of any one or more of the elements and/or features set forth in relation to embodiments within this disclosure, with any one or more of any other elements and/or features of any other embodiment(s) set forth in this disclosure. These combinations further include the incorporation of the features and/or limitations of any dependent claim set forth, singly or in combination with features and/or limitations of any one or more of the other dependent claims, with features and/or limitations of any one or more of the independent claims, with the remaining dependent claims in their original text being read and applied to any independent claims so modified. These combinations also include combination of the features and/or limitations of one or more of the independent claims with features and/or limitations of another independent claims to arrive at a modified independent claim, with the remaining dependent claims in their original text or as modified per the foregoing, being read and applied to any independent claim so modified or formulated. Inventions present herein have been disclosed and claimed with the intent to embrace modifications and alterations that achieve substantially the same result as herein taught using substantially the same or similar structures, not known in the prior art without the benefit of the teachings herein, being limited only by the broadest permissible and applicable construction of the claims which follow.

1. Method useful in controlling a production line process that utilizes a raw material provided on a roll as a moving feed, comprising:
defining an amount of said raw material that is desired to be left on said roll when said roll is to be considered as being depleted;
feeding said raw material into said production line during the operation of said process;
determining a stop length of said raw material that passes through said production line when feeding of said raw material into said production line process is decelerated to a stop;
determining the amount of material present on said roll during the operation of said production line;
relating said amount of material present, said stop length and said amount of said raw material desired to be left on said roll to one another, to provide a comparison; and
commanding an action concerning the operation of said production line responsive to said comparison.

2. Method according to claim 1 wherein determining the amount of material present on said roll is based on sensor inputs from a first sensor configured to measure the length of material from said roll that passes through said production line during said process within a selected time frame, and a second sensor configured to measure revolutions of said roll during said production process.

3. Method according to claim 1 wherein determining the amount of material present on said roll is based on sensor input from a first sensor configured to measure the speed of material from said roll that passes through said production line during said process, and a second sensor configured to measure revolutions of said roll during said production process.

4. Method according to claim 1 wherein said amount of said raw material desired to be left on said roll is defined to be less than about 1% of the amount of said raw material initially present on said roll.

5. Method according to claim 1 wherein said amount of said raw material desired to be left on said roll is defined to be about zero.

6. Method according to claim 1 wherein determining the amount of material present on said roll during the operation of said production line is carried out repeatedly while said raw material passes through said production line.

7. Method according to claim 1 wherein said action comprises a signal to stop said production line.

8. Method according to claim 7 wherein said signal is an electronic signal provided to control equipment configured to cause the feed of said raw material into said production line to cease.

9. Method according to claim 1 wherein said action comprises a signal to provide a fresh roll of raw material.

10. Method according to claim 9 wherein said signal is selected from the group consisting of: an audible signal, and a a visual signal.

11. Method according to claim 9 wherein said step of determining a stop length is omitted, and wherein said production line is configured to change to a new roll without cessation of feed of rolled stock raw material, said signal comprising an electronic signal to automated equipment in control of automatically cutting over to a new roll.

12. Method according to claim 1 wherein said comparison is based on said amount of material present on said roll and said amount of said raw material desired to be left on said roll.

13. Method according to claim 1 wherein said comparison is based on said amount of material present on said roll and the sum of said stop length and said amount of said raw material desired to be left on said roll.

14. Method according to claim 5 wherein said comparison is based on said amount of material present on said roll and said stop length.

15. Method according to claim 1 wherein said relating is carried out by a microprocessor.

16. Method according to claim 15 wherein said relating is carried out repeatedly at any selected intervals of time as said raw material passes through said production line, to provide a plurality of successive comparisons.

17. Method according to claim 1 wherein said stop length is repeatedly calculated during said process based on repeatedly determined time intervals required for the process to fully stop based on current line speed.

18. Method according to claim 1 wherein said amount of material present on said roll is repeatedly calculated during said process based on repeatedly determined values for the thickness of the material present on said roll.

19. System for controlling a production line process that utilizes a raw material provided on an unwinding roll as a feed, comprising:
a first sensor having an output that provides an indication of the length of said material passing through said production line over time;
a second sensor having an output that provides an indication of revolutions of said roll which transpire during said process;
a microprocessor having memory and configured to receive a plurality of inputs, including the outputs from said first sensor and said second sensor, and configured to provide at least one process control output responsive to said first and said second sensor inputs,
said microprocessor being further configured to receive a data input relating to the outer diameter of the core on which said raw material is disposed.

20. System according to claim 19 wherein said process control output is selected from the group consisting of: a command to stop said production line, and an indication to furnish said production line with a fresh roll of raw material.

21. System according to claim 19 wherein said microprocessor is further configured to:
determine the amount of material present on said roll;
determine the amount of raw material that passes through said process when said process is commanded to be stopped (stop length); and
receive an input relating to the amount of material that is desired to be left on said roll when said roll is considered as being depleted (length margin).

22. System according to claim 21 wherein said microprocessor is further configured to determine when said amount of material present on said roll is substantially equal to the sum of said length margin and said stop length.

23. System according to claim 19 wherein said output is based on a determination of the stop length of said raw material that passes through said production line when feeding of said raw material into said production line is halted.

24. System according to claim 19 wherein said output is based on a determination of the amount of material present on said roll during the operation of said production line.

25. System according to claim 19 wherein said output is based on a determination of a relationship between the amount of material present on said roll during the operation of said production line, the stop length of said raw material that passes through said production line when feeding of said raw material into said production line is halted, and a pre-defined amount of said raw material desired to be left on said roll.

26. System according to claim 19 wherein said microprocessor is further configured to:
a) register a count of revolutions of said roll;
b) determine the diameter of said roll;
c) determine the thickness of the material present on said roll;
d) determine the amount of material present on said roll; and
e) is optionally further configured to determine the amount of material that passes through said process when said process is commanded to be stopped.
